(19) United States
(12) Patent Application Publication
(10) Pub. No.: US 2006/0206851 A1
(43) Pub. Date: Sep. 14, 2006

(54) Determning lithographic parameters to optimise a process window

(75) Inventors: Johannes Van Wingerden, Leuven (BE); Casparus Anthonius Henricus Juffermans, Leuven (BE); Peter Dirksen, Leuven (BE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/540,068

(22) PCT Filed: Dec. 18, 2003
(86) PCT No.: PCT/IB03/06094

§ 371 Date: Jun. 22, 2005

(30) Foreign Application Priority Data
Dec. 30, 2002 (EP) 02080594.1

(51) Int. Cl. G06F 17/50

(52) U.S. Cl. 716/19

(57) ABSTRACT

For determining best process variables (E, F, W) setting that provide optimum process window for a lithographic process for printing features having critical dimensions (CD) use is made of an overall performance characterizing parameter (Cₚₖ) and of an analytical model, which describes CD data as a function of process parameters, like exposure dose (E) and focus (F). This allows calculating of the average value (μCD) and the variance (σCD) of the statistical CD distribution (CDd) and to determine the highest Cₚₖ value and the associated values of process parameters, which values provide the optimum process window.

The invention relates to a method of determining best process variables setting that provides optimum process window for a lithographic production process comprising transferring a mask pattern into a substrate layer, which process window is constituted by latitudes of controllable process parameters and which method comprises the steps of:
acquiring a data set of a focus-exposure matrix for a feature of the mask pattern having critical dimension (CD), which feature has a predetermined design CD value being the CD value that should be approximated as close as possible when transferring the feature to the substrate layer, and
checking whether transferred images of the feature meet design tolerance condition, and determining which combination of values of controllable process variables provides the CD value closest to the design value and the best process latitude.

The invention also relates to a method of process window setting using this method, to a lithographic process using the process window setting method and to a device manufactured by means of the lithographic process.

A process window, or process latitude, is understood to mean the combination of latitudes of the process variables, which can be controlled by the user of a lithographic projection apparatus. The process variables, like focus and exposure dose, have a nominal value that is determined by the CD design value, i.e. the CD value that results from the design of the device that is to be manufactured. The CD value that is realized in the substrate may deviate in the range of, for example, +10% to −10% and the process variables value may deviate from their nominal value in a corresponding range, whereby the sum of the process variables latitudes should not exceed the budget for the process window.

A focus exposure matrix, FEM, is understood to mean the total data set obtained if a same feature is imaged a number of times at different positions in a resist layer on top of the substrate, whereby each image is formed by a different focus setting and/or a different exposure dose setting and measuring the formed images. This measuring may, for example be performed by scanning the resist layer by means of a dedicated scanning electron microscope (SEM), after the resist has been developed. The FEM data are usually represented by a Bossung plot, which shows the realized CD value as a function of focus and exposure dose. The FEM data may also be obtained by means of a simulation program wherein the controllable process variables are inputted.

The method as defined above is known from EP-A 0 907 111, which discloses a photo mask, a method of producing the same, a method of exposing using the same and a method of manufacturing a semiconductor device using the same.

In the art of semiconductor device fabrication there is an ever-increasing demand for high density and performance, which require decreasing device features, increased transistor and circuit speed and improved reliability. Such demands require formation of device features with high precision and uniformity, which in turn necessitates careful settings of process variables.

One important process requiring careful setting of process variables and mutually optimization of these is photolithography wherein masks are used to transfer circuitry patterns to semiconductor substrates, or wafers. A series of such masks are employed in a preset sequence. Each of these masks is used to transfer its pattern onto a photosensitive (resist) layer which has been previously coated on a layer, such as a polysilicon or metal layer formed on the silicon wafer. To transfer the pattern an optical projection apparatus, also called exposure apparatus or wafer stepper or -scanner, is used. In such an apparatus UV radiation or deep UV (DUV) radiation is directed through the mask to expose the resist layer. After exposure the resist layer is developed to form a resist mask, which mask is used to selectively etch the underlying polysilicon or metal layer in accordance with the mask to form device feature such as lines or gates.

For the design and fabrication of a mask pattern a set of predetermined design rules, which are set by design and processing limitations has to be followed. The design rules define the tolerances of the width of device features, for example lines, and of the space between these features to ensure that printed device features or lines do not overlap or interact with each other in undesirable ways. The design rule limitation is referred to as the critical dimension (CD). The term CD is currently used for smallest width of a line or the smallest space between two lines that is permitted in the fabrication of the semiconductor device. For current devices the CD on substrate level is of the order of a micron. CD may, however also relate to the limitations set by the process window.

The critical dimension varies as a function of a/o the focus and exposure dose value. Exposure dose is understood to mean the amount of radiation energy, per surface area unit, of the exposure beam incident on the resist layer. The focus value relates to the degree in which the mask pattern image is focused in the resist layer, i.e. the degree in which this layer coincides with the image plane of the projection system of the lithographic apparatus.

For each new generation ICs or other devices manufactured by means of lithography the size of the device features becomes smaller and process windows shrink. Process window, or process latitude, is understood to mean the margin for error in processing. If the latitude is exceeded, surface features' CD, as well as their cross-sectional shape (profile) will deviate from the design dimensions and this will adversely affect the performance of the manufactured semiconductor device. So there is an increasing need for a method to optimize several lithography variables in order to allow printing of the desired small features, i.e. transferring these features to the resist layer and the relevant substrate layer, with sufficient process latitude. First of all the optimum dose and focus setting for printing the required features need to be determined. Furthermore the illumination setting, i.e. the shape of the illumination beam cross-section and the intensity distribution, can be chosen such as to optimize the process latitude. Optimization of other parameters, like mask bias and scattering bars are additional means available to the lithographic engineers.

The mask bias is a parameter that relates to the fact that the printed width of a feature will deviate from the width of the associated design feature dependent on the density of the structure of which the feature forms part. For example, a design feature of a dense structure, e.g. the spacing between successive features is equal to the feature width will be printed as a feature having the same width as the design feature. For a semi-dense structure, e.g. the spacing between the features is three times the design width, the width of the printed feature will be smaller, for example 2%, than the width of the design feature. For an isolated feature, i.e. a feature having no other feature in its neighborhood, the printed width will be even smaller, for example 5%.

Scattering bars are mask features arranged in the neighborhood of design features and so small that they are not imaged as such. However due to their diffraction properties they have influence on the image of the design feature and allow correction of the dimension of a proximate design feature. Their effect is called optical proximity correction (OPC).

Finding the optimum process conditions for printing a mask design pattern, which comprises different, structures having different pitches (periodicity's) is even more complicated. For example, using an over- or under-exposure dose in combination with a proper mask bias might improve the process latitude for some of the structures, while it reduces that for the other structures. In view of the shrinking process latitudes for the manufacture of devices with ever decreasing feature width it is of ever greater importance to determine the lithographic process conditions for which the largest process latitude is achieved. In general, this is achieved by comparing the process latitudes obtained for different combinations of process parameters.

In currently used optimization methods, which employ software programs, the process latitude for a given lithographic process, two process variables are used: the focus latitude and the dose latitude. For a predetermined maximum CD variation focus latitude is specified for a given dose latitude or, alternatively dose latitude is specified for a given focus latitude. Sometimes, maximum focus and exposure dose latitudes are used. In the conventional optimization method use is made of the well-known focus-exposure dose-matrix (FEM) to determine the optimum focus and exposure dose for a given feature CD.

The method of EP-A 0 907 111, cited herein above, allows optimization not only of focus and exposure, but also of the mask CD and optimization is performed at the hand of variations of three process parameters: focus, exposure dose and mask CD. The procedure is as follows:

vary the values of two of the three parameters, i.e. make a FEM for a given value of the third parameter and determine whether the CD on the substrate satisfies the specification;

repeat this measurement and determination repeated for a series of values of the third parameter and determine all combinations of the first two parameter values for which the wafer CD satisfies the specification, thus obtaining the useful range for the third parameter, and

optimize the range of the third parameter as a function of another important parameter, like the mean mask CD, the mean exposure dose, the mask transmission etc.

This procedure is substantially the same as the classical two-parameter optimization method; the only difference is that three instead of two parameters are involved. The optimization is a yield optimization. All parameter values, which result in a wafer CD value within the specification, for example within +10% and −10% of the design CD value, are accepted.

The conventional optimization method just provides maximum latitude for one parameter at some pre-specified values for the other (one or two) parameter(s). Moreover if the obtained process latitude is larger than initially required, it is not clear how this can be used to improve CD control. There is thus a need for an optimization method, which is more general and allows better process settings and mask design corrections.

It is an object of the invention to provide such an optimization method, which allows obtaining minimum spread in wafer CD values as well as an average wafer CD value, which is equal to the design value. Moreover this method is very efficient with respect to the time needed for calculating the mean value and the spread. This method is characterized in that the process of checking and determining the best combination comprises the steps of:
1. defining a statistical distribution of relevant process variables, the parameters of the distribution being determined by estimated or measured variations of the process variables;
2. fitting the coefficients (b₁- bₙ) of an analytical model (CD(E, F)) that describes the CD value as a function of the process variables focus (F) and exposure dose (E);
3. calculating the average CD value and the variance of the CD distribution using the analytical model CD(E, F) of step 1);
4. determining quantitatively how-the CD distribution fits to a desired process control parameter Cₚₖ; and
5. determining the best process setting for the design feature by determining the exposure-dose value and the focus value which provide a maximum Cₚₖ value.

The use of an analytical model allows calculating the Cpk value in an analytical, time saving, way as a function of the coefficients of the model and the actual measured or expected or estimated values of the process latitudes, i.e. process variations expressed in terms of the parameters of the distribution of the process variables.

A preferred embodiment of the method, wherein at least one other process variable is included, is characterized in that a number of values for the another parameter are introduced, in that in step 1) the coefficients of the model are interpolated as a function oft the other parameter, in that between step 2) and step 3) an additional step is carried out comprising:

2a) determining for each possible E and F combination the value of the other variable that is needed to form a printed feature having the size of the design feature, thereby using the interpolated E and F values of step 2);

in that steps 3) and 4) are carried out for each value of the other process parameter, and in that in step 5) the exposure dose value, the focus value and the value of the other parameter which provide the maximum Cₚₖ value are determined.

An embodiment of the latter method is characterized in that the other process variable is a mask bias.

The other variable may also be another mask variable, like a scatter bar width or its position or the size and position of additional mask features, like hammerheads, serifs etc.

After the process variables focus and exposure dose the mask bias is the first variable to be considered for optimizing a lithographic process. However also other process variables may be used in the optimization process instead of or in addition to the mask bias.

An embodiment of the method, which is suitable for a process for printing a mask pattern having different structures is characterized in that the Cₚₖ of the structure having the smallest Cₚₖ value at the predetermined focus and exposure dose is used to determine the overall process window for all structures in the mask pattern at that focus and exposure dose.

The structure having the smallest Cₚₖ may be called critical structure, because it comprises the most difficult mask feature.

By means of additional steps of optimizing over exposure dose (E) and focus (F) and determining the E, F set point providing the largest of the ‘smallest Cₚₖ values’, the best E, F set points as well as the overall process Cₚₖ.

By taking the Cₚₖ of the critical structure as a reference in the optimization, it is ensured that the result is correct also for structures, which have a higher Cₚₖ value.

The invention also relates to a method for setting optimum process window for use in a lithographic production process, which process comprises transferring a mask pattern in a substrate layer and which method comprises determining optimum process window and setting controllable process variables according to this window. This method is characterized in that the optimum process window is determined by means of the method as described herein above.

The invention further relates to a lithographic process for manufacturing device features in at least one layer of a substrate, which process comprises transferring a mask pattern into the substrate layer by means of a projection apparatus thereby using an optimized process window defined by latitudes of controllable process parameters, characterized in that the process window is optimized by means of the method as described hereinabove.

As a lithographic process wherein the new process window optimization method is used produces more accurate devices and has an increased yield, this process forms part of the invention.

As a device manufactured by means of such a lithographic process has a better chance to satisfy a predetermined specification, the invention is also embodied in such a device.

The invention further relates to a dedicated computer program product for use with the method as described above, which computer program product comprises programmable blocks for programming a programmable computer according to the processing steps of the method.

As the novel method encompasses determining an optimum design for a mask pattern, the invention is also embedded in such a mask pattern that has been optimized by means of the method.

These and other aspects of the invention are apparent from and will be elucidated, by way of non-limitative example, with reference to the embodiments described herein after. In the drawings:

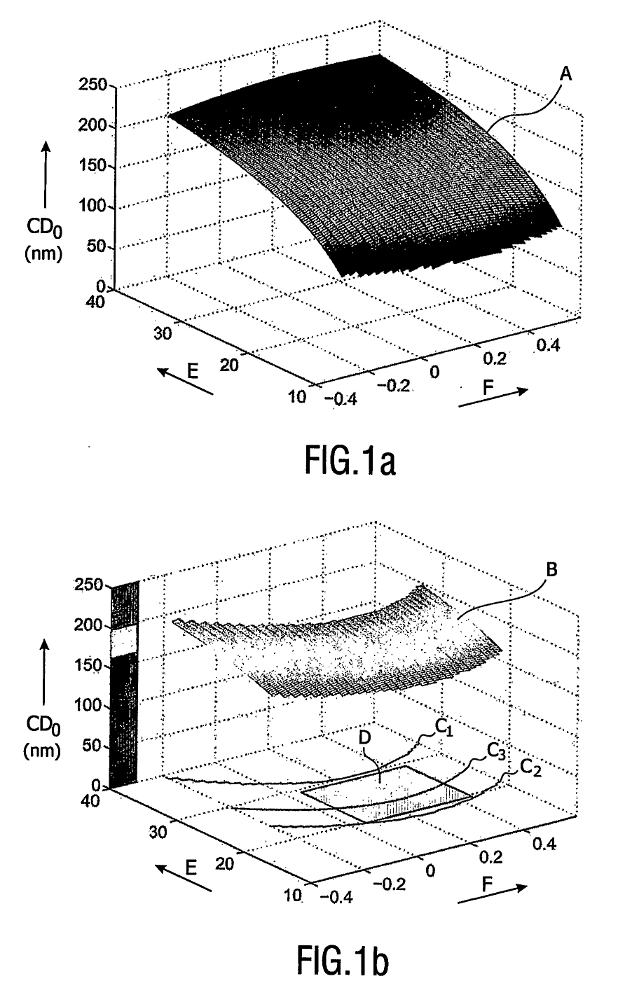

FIG. 1a shows a surface plot of CD values as a function of exposure dose and focus;

FIG. 1b shows such a plot for CD values within a predetermined specification and the associated exposure-dose, focus window;

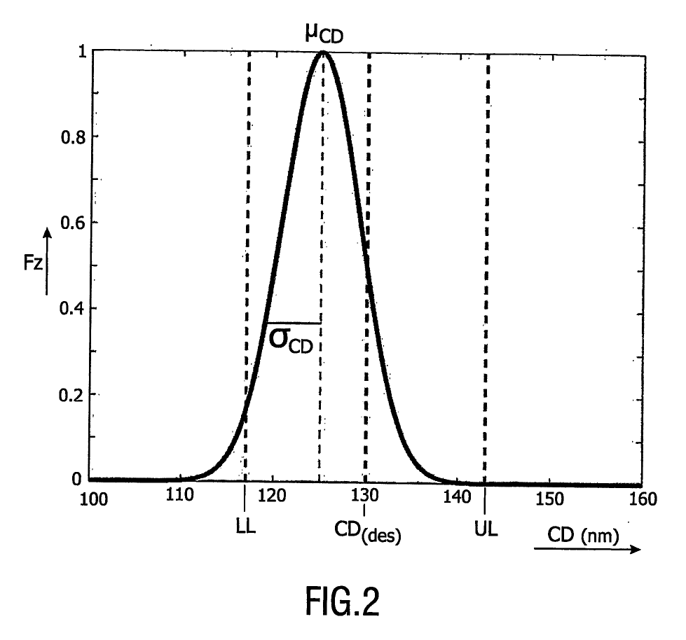

FIG. 2 shows a Gaussian distribution of CD values;

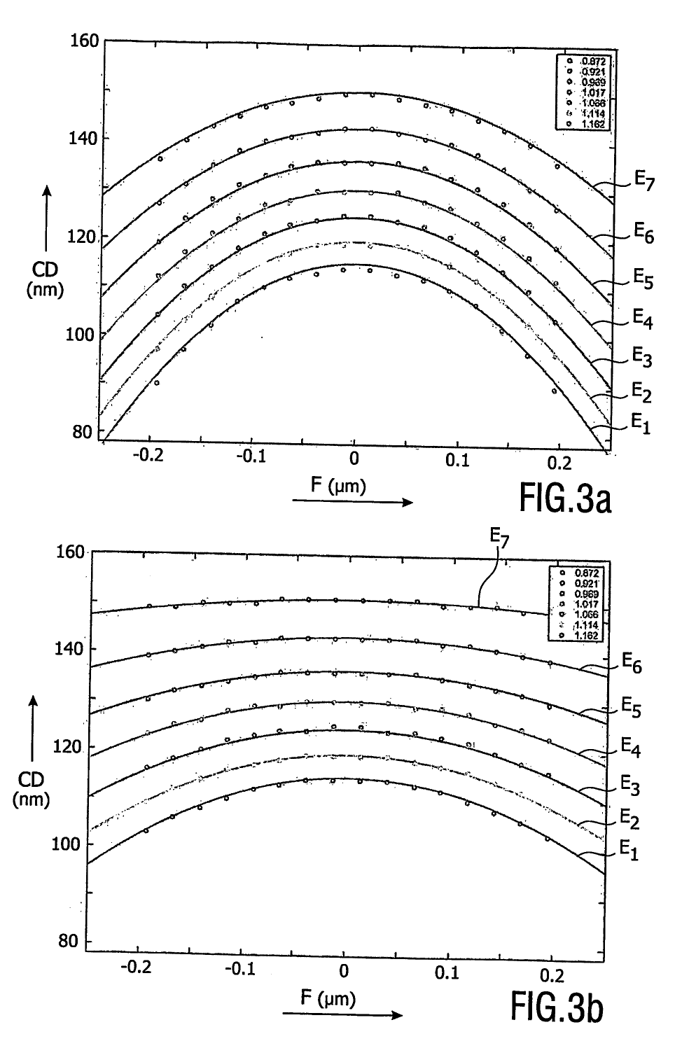

FIGS. 3a and 3b shows an example of iso-exposure-dose curves for an isolated feature and for such a feature from a semi-dense pattern, respectively;

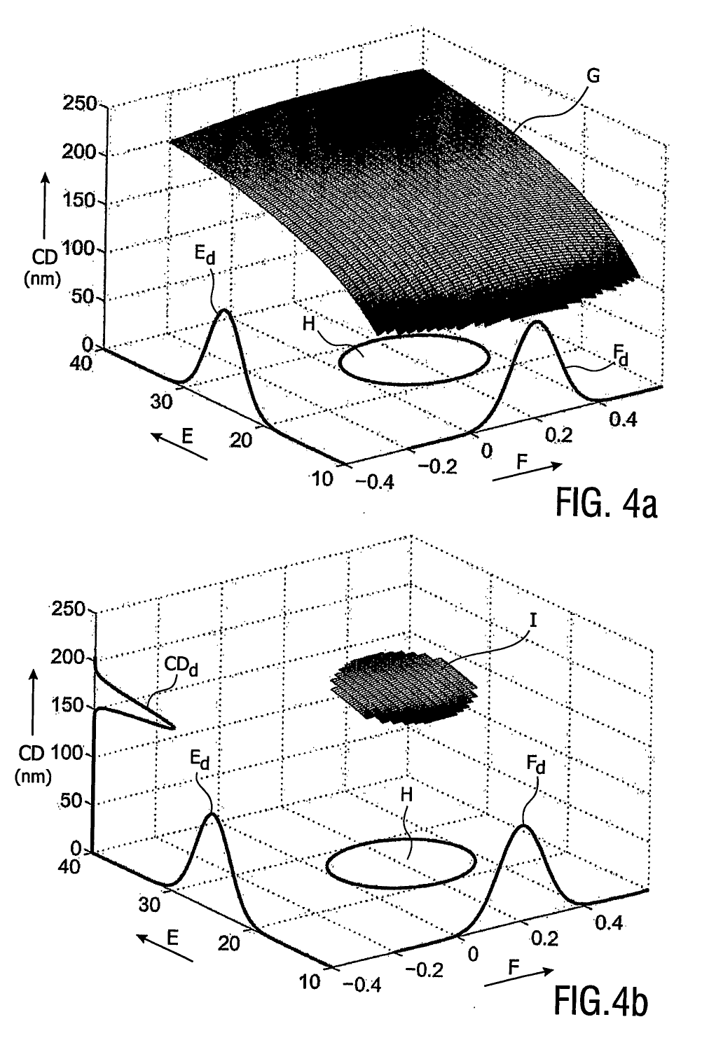

FIG. 4a shows a surface plot of measured CD values and the associated focus and exposure-dose distributions;

FIG. 4b shows such a plot for CD values resulting from the combined predetermined distributions of focus and exposure dose;

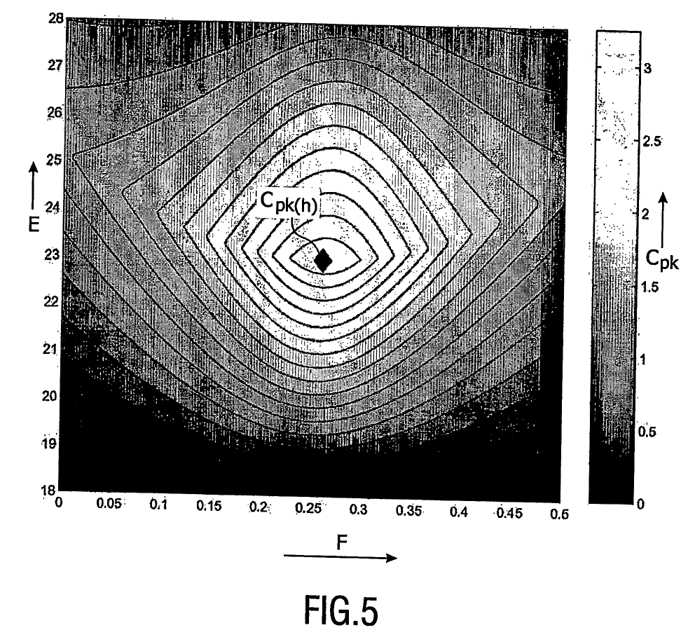

FIG. 5 shows an example of Cₚₖ values as a function of focus and exposure dose set points values;

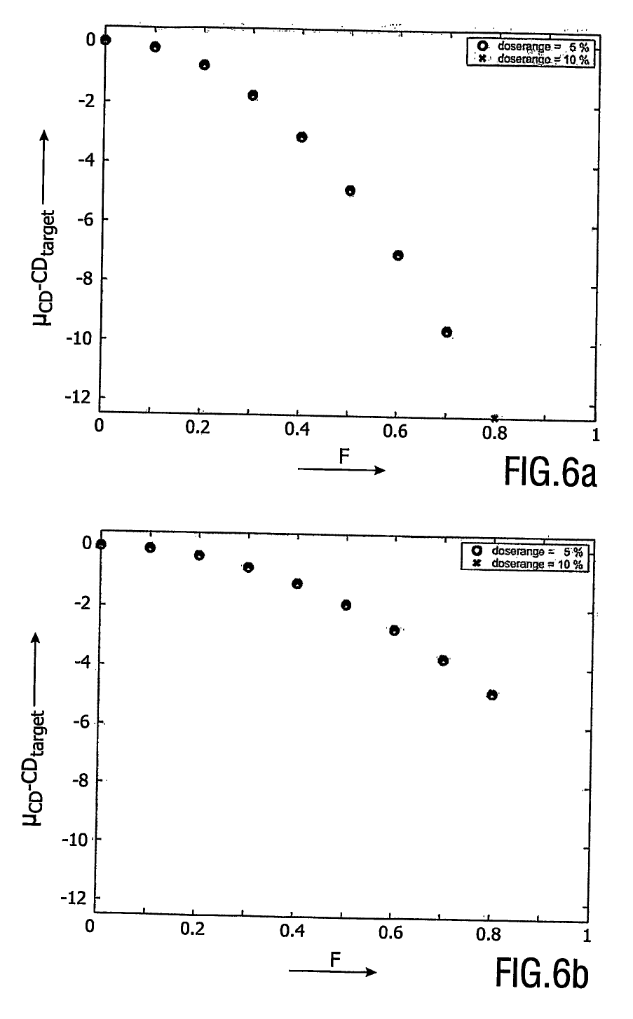

FIGS. 6a and 6b shows an example of the variation of the average CD value as a function of exposure-dose and focus variations around their set points for an isolated feature and for such a feature from a semi-dense pattern, respectively;

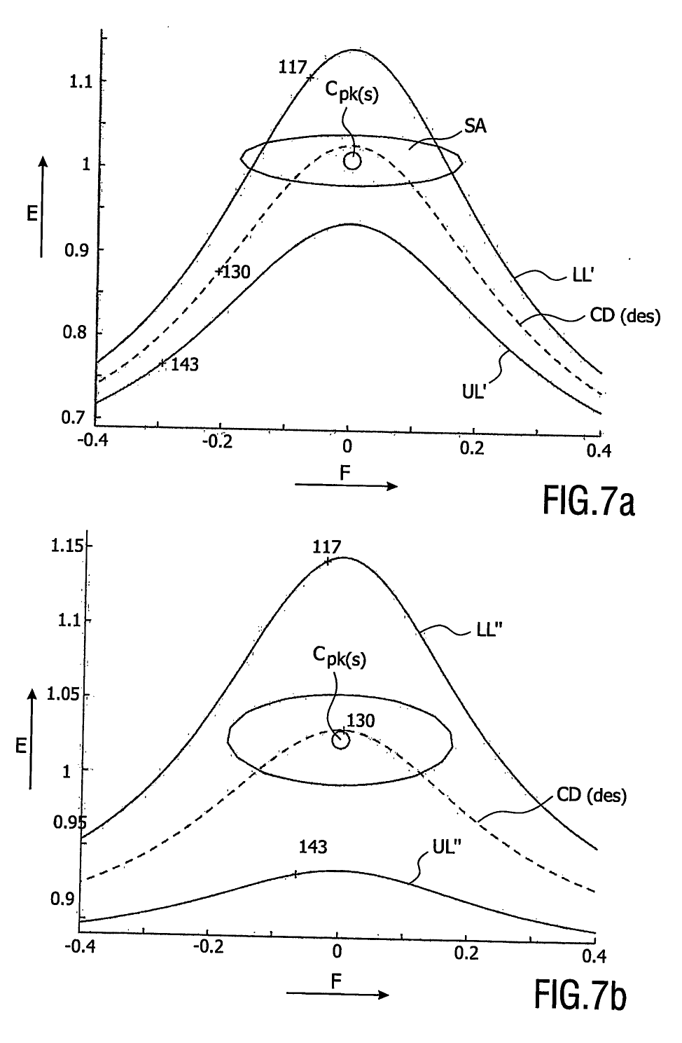

FIGS. 7a and 7b shows an example of the best process set point obtained with the optimization method of the invention for an isolated feature and for such a feature from a semi-dense pattern;

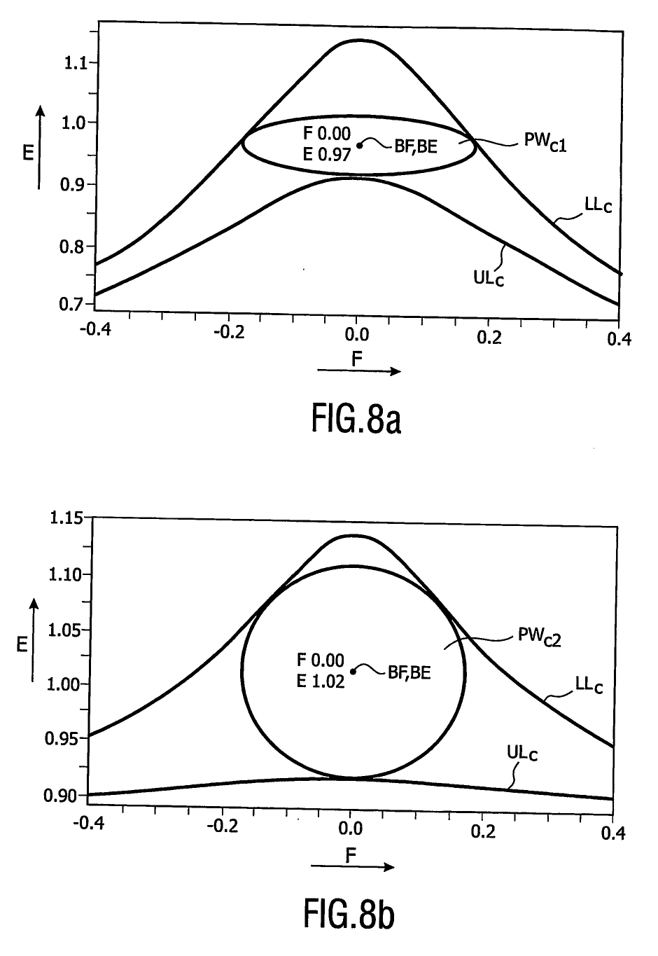

FIGS. 8a and 8b shows an example of process windows obtained with a conventional optimization method for an isolated feature and for such a feature from a semi-dense structure, and

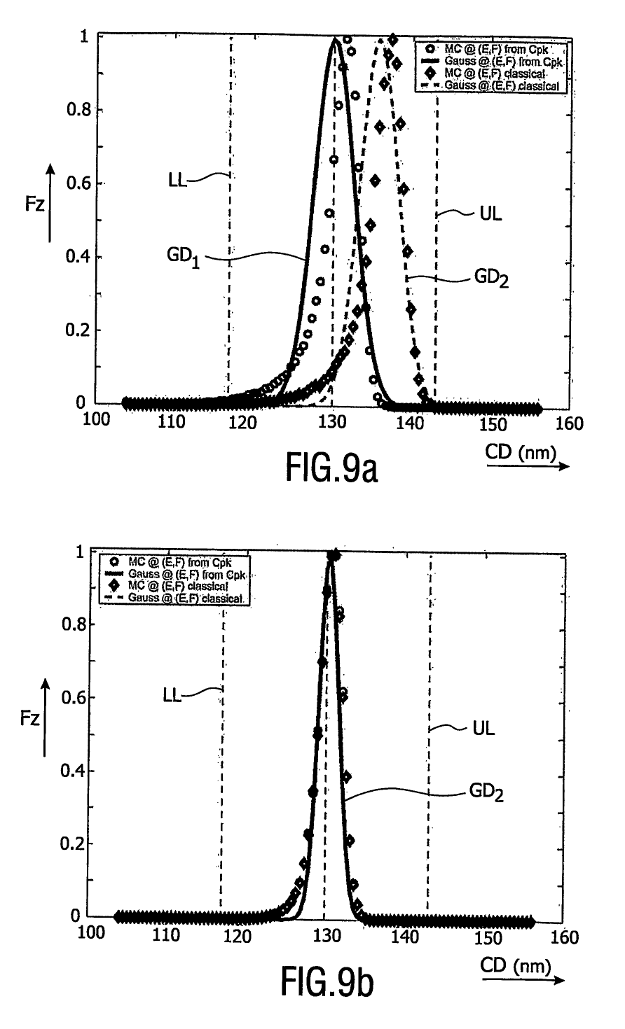

FIGS. 9a and 9b shows an example of a first CD value distribution obtained with the new optimization method and a second distribution obtained with a conventional optimization method for an isolated feature and for such a feature from a semi-dense pattern.

The first step of a method for determining the optimum process window for a lithographic process is, determining all focus and exposure dose combinations, which result in substrate CD values, i.e. CD values realized in the developed resist layer, within predetermined upper and lower limits for these CD values. Usually these limits are +10% and −10% from the design CD (CD_{d}) value. This determination step can be performed by exposing a number of areas of a resist layer on a test substrate (target areas) with the same a mask pattern comprising the CD feature, whereby for each exposure another focus and/or exposure dose setting is used. After development of the resist and measuring the features formed in the resist layer, usually by means of a dedicated scanning electron microscope (SEM) a focus-exposure-matrix (FEM) is obtained. Alternatively, the different focus and exposure dose settings may be put in a simulation program run on a computer which calculates the CD values resulting from these settings.

FIG. 1a shows an example of a plot of a FEM, or CD(E, F), data set thus obtained for a design CD of 130 nm. The exposure-dose and focus values (both in arbitrary units) are plotted along the axes DO and FO, respectively, in the horizontal (focus-dose) plane whilst the obtained CD values are plotted along the vertical axis CDo. FIG. 1a shows the full data set.

In the conventional method of determining the process window, the focus and exposure settings, which result in CDo values out of specification, i.e. values smaller than the predetermined lower limit and larger than the upper limit are removed. A data set as shown in FIG. 1b remains. The exposure dose and focus values corresponding to the allowable CD values are within the area in the focus-dose plane delimited by the curves C1 and C2. These curves are determined by the CDd+10% and the CDd−10% values mentioned above. The curve C3 between the curves C1 and C2 corresponds to the nominal, or design, CD value. The process window is determined by fitting an area A, which is rectangular or an elliptical area, between the curves C1 and C2. The maximum size of that rectangular or elliptical area is than taken as the magnitude of the process window and its center as the best focus-best dose setting. The choice for an ellipse, instead of for a rectangle, reflects the fact that the chance that at the same time both a focus value and an exposure dose value is at the outer part of its distribution is much less likely than that only one of them is. In fact, if both the focus values and the exposure dose values show a Gaussian distribution, the contour of equal probability of occurrence is an ellipse. The axes of this ellipse should then be scaled proportional to the standard deviation of the distributions.

Several methods can be used for exactly maximizing the process window, which methods are only slightly different from each other. Often, the required latitude for one of the process parameters is fixed at a desired value and the other parameter is maximized. Thus, for example, for a predetermined depth of focus the exposure dose the largest latitude is obtained.

The result of the conventional method is not optimized for the specific statistical distribution of focus and exposure dose errors. Moreover if the obtained process latitude, or-window, is larger than required one it can not be predicted what the exact improvement in the CD control would be.

The process window optimization method of the present invention, which determines the energy dose and focus combination with the largest process window in another way, does not suffer from these disadvantages. The new method differs from conventional methods in that;

the average and standard deviation of the measured CD values are directly calculated from the distributions of the focus and exposure dose values.

use is made of the process capability index, or parameter, Cₚₖ to predict the CD values, which will be obtained from the process with these focus and exposure dose distributions. First the Cₚₖ parameter and the interpolation model, used for calculating CD values as a function of focus and exposure dose and then the complete method will be described.

The Cₚₖ parameter is currently widely used during the production of ICs or other devices to control an installed production process in a manufacture site, also called Fab. Up to now this parameter has not been used to find the best process settings and mask design corrections, by means of software tools used by lithographic experts.

The Cₚₖ parameter is related to the statistical distribution of the CD value and the deviation of the average of this value from the target, or design, value. FIG. 2 shows an example of a CD distribution for a design CD value, CD(des), of 130 nm. The distribution has an average CD (μ_{CD}) value of approximately 125 nm and a standard deviation of approximately 4 nm. The minimum and maximum acceptable CD values are set at −10% and +10%, respectively of the design value, which is indicated by the dashed lower limit (LL) and upper limit (UL) lines. The process capability parameter Cₚₖ is defined as:

$$\begin{matrix}{C}_{pk} = \frac{min ( \vert {μ}_{CD} - LL \vert , \vert UL - {μ}_{CD} \vert )}{3 σ} & for LL \leq {μ}_{CD} \leq UL \\ {C}_{pk} = 0 & for LL > μ CD > UL\end{matrix} \qquad ( 1 )$$

The nominator, and thus the Cₚₖ parameter for a given 3σ value, is maximum if the average μ_{CD} is equal to the design CD value, i.e. is positioned midway between the lower limit LL and the upper limit UL. Reducing the width of the CD value distribution will increase the Cₚₖ parameter because the 3σ value in the denominator decreases then. In the example of FIG. 2 the Cₚₖ value is about 0.6. In case of production process control a Cₚₖ value of 1 is often taken as the lower limit for achieving a good process control. Such a Cₚₖ value is obtained if the average CD value is centered between the upper and lower limits and if the 3σ points are located at these limits. If the Cₚₖ parameter is larger than 1, the production process performs satisfactorily, whilst if the Cₚₖ parameter is lower than one, it does not.

For determining process windows according to the invention an interpolation model is used to describe the obtained CD values, i.e. the values of the FEM, as a function of the considered process variables. This model, herein after: the FEM interpolation model, can be best understood by taking two process variables: the focus (F) and exposure-dose (E) into account. For these two process variables the model is:
CD(E,F)=b₁.(F²/E)_{—}+b₂.F²+b₃.(F/E)+b₄.F+b₅.(1/E)+b₆ (2)

By means of this model the, simulated or measured, CD values can be fitted along curves, for example iso-exposure curves, i.e. curves fitted through CD values having been obtained by means of the same exposure dose and different focus settings.

FIG. 3a show such curves for a 130 nm wide isolated feature, or line and FIG. 3b shows such curves for a 130 nm wide feature out of a periodic pattern having a pitch of 310 nm. Along the horizontal axis defocus values (in microns) are plotted and along the vertical axis CD values (in nm). The simulated CD values are represented by dots, of different shapes for different exposure doses. The exposure doses d₁-d₇ respectively are: 1.162, 1.114, 1.068, 1.017, 0.969, 0.921 and 0.872 Joules/cm². The fitted iso-exposure dose curves are parabolas.

Currently used optimization methods do not use the six-parameter model of equation (2), but a polynomial of only E-terms, for example:

$$CD = {\sum }_{i = 0}^{3} {\sum }_{j = 0}^{4} {a}_{ij} {E}^{i} {F}^{j}$$

The iso-focal exposure dose is defined as the exposure dose for which the second derivative to focus is zero:

$$E = {E}_{iso} if \text{:} \frac{{\partial }^{2} CD}{\partial {F}^{2}} = 0 -> {E}_{iso} = \text{-} \underline{{b}_{1} / {b}_{2}} \qquad ( 3 )$$

As shown in FIGS. 3a and 3b the spacing between the iso-exposure curves decreases if the exposure doses increase.

In qualitative terms, the new process optimization method uses one characteristic parameter, not being a process variable, to determine a setting of proper process variables such that the average of the CD distribution is equal to the design value and such that the CD variation is as small as possible. Said CD distribution is the result of the chosen focus and exposure dose (F, E) set points and the variation of the focus and exposure around these set points.

For each of these set points and variations the associated CD values are calculated by means of the FEM interpolation function (Equation (2). However it is also possible to derive from equation (2) of the model anther equation for the mean value and standard deviation of the CD distribution.

FIG. 4a shows an example of a distribution CD(E,F) of such CD values as a function of exposure dose and focus, which CD values are situated on a surface G similar to surface A in FIG. 1a. It is noted that FIGS. 4a and 4b relates to other CD values than the 130 nm value discussed herein above. Also shown in FIG. 4a are the exposure dose and focus distributions Ed and Fd, respectively around the set points of the exposure dose and focus. All exposure dose and focus values for which, in the given focus and dose variations, the occurrence probability exceeds a given minimum are situated in the elliptical area G in the EF plane. The elliptical shape of the area G results from the fact the assumption that the deviations of the focus values from the focus set point are not correlated with the deviations of the exposure dose values from the exposure dose set point. The CD values, which correspond to the E and F values within the area G are situated in the area H, shown in FIG. 4b. This Fig. shows also the CD value distribution (CDd), which is plotted along the vertical, CD, axis.

To determine for this CD distribution the best exposure-dose and focus settings for the envisaged lithographic process, the parameter Cₚₖ is calculated using equation (1). By maximizing the Cₚₖ values for all possible exposure dose and focus settings, the best E and F settings are obtained.

In the calculation according to the new method it is assumed that the distribution of the exposure dose and focus values p(E) and p(F) are Gaussian distributions:

$$\begin{matrix}p ( E ) = \frac{1}{{σ}_{E} √ 2 π} \cdot {ⅇ}^{- 1 / 2 [ ( E - {μ}_{E} ) / {σ}_{E} ] 2} & ( 4 ) \\ p ( F ) = \frac{1}{{σ}_{F} √ 2 π} {ⅇ}^{- 1 / 2 [ ( F - μ F ) / σ F ] 2} & ( 5 )\end{matrix}$$

wherein μ_{E} and μ_{F} are the average exposure dose and focus values and σE and σF are the standard deviations of the exposure dose and focus distributions. For the exposure dose and focus distributions of equations (4) and (5) the average value and the standard deviation of the resulting CD distribution can be calculated by means of the CD(E,F) function of equation (2). Thereby terms up to the second derivatives of the CD to the exposure dose and focus are included in the calculation. The average value, μ_{CD}, of the CD distribution is given by:
μ_{CD}=CD(μ_{E},μ_{F})+σ_{F}²{(b₁/μ_{E})+b₂}+(σ_{E}²/μ_{E}³){b₁(μ_{F}²+σ_{F}²)+b₃μ_{F}+b₅} 96)

The variance of the CD distribution is given by:

$${σ}_{CD}^{2} = {σ}_{F}^{2} ( 1 / {μ}_{E}^{2} ) \cdot ( {b}_{3}^{2} + 4 {b}_{13} {μ}_{F} + 4 {b}_{1}^{2} {μ}_{F}^{2} ) + {σ}_{F}^{2} ( 1 / {μ}_{E} ) \cdot ( 2 {b}_{34} + 4 ( {b}_{23} + {b}_{14} ) {μ}_{F} + 8 {b}_{12} {μ}_{F}^{2} ) + {σ}_{F}^{2} \cdot ( {b}_{4}^{2} + 4 {b}_{24} {μ}_{F} + 4 {b}_{2}^{2} {μ}_{F}^{2} ) + {σ}_{F}^{4} ( 1 / {μ}_{E}^{2} ) \cdot 2 {b}_{1}^{2} + {σ}_{F}^{4} ( 1 / {μ}_{E} ) \cdot 4 {b}_{12} + {σ}_{F}^{4} \cdot 2 {b}_{2}^{2} + {σ}_{E}^{2} ( 1 / {μ}_{E}^{4} ) \cdot ( {b}_{5}^{2} + 2 {b}_{35} {μ}_{F} + ( {b}_{3}^{2} + 2 {b}_{15} ) {μ}_{F}^{2} + 2 {b}_{13} {μ}_{F}^{3} + {b}_{1}^{2} {μ}_{F}^{4} ) + {σ}_{E}^{2} {σ}_{F}^{2} ( 1 / {μ}_{E}^{4} ) \cdot ( 3 {b}_{3}^{2} + 2 {b}_{15} + 14 {b}_{13} {μ}_{F} + 14 {b}_{1}^{2} {μ}_{F}^{2} ) + {σ}_{E}^{2} {σ}_{F}^{2} ( 1 / {μ}_{E}^{3} ) \cdot ( 2 {b}_{34} + 4 ( {b}_{23} + {b}_{14} ) {μ}_{F} + 8 {b}_{12} {μ}_{F}^{2} ) + {σ}_{E}^{2} {σ}_{F}^{4} ( 1 / {μ}_{E}^{4} ) \cdot 7 {b}_{1}^{2} + {σ}_{E}^{2} {σ}_{F}^{4} ( 1 / {μ}_{E}^{3} ) \cdot 4 {b}_{12} + {σ}_{E}^{4} ( 1 / {μ}_{E}^{6} ) \cdot ( 2 {b}_{5}^{2} + 4 {b}_{35} {μ}_{F} + ( 2 {b}_{3}^{2} + 4 {b}_{15} ) {μ}_{F}^{2} + 4 {b}_{13} {μ}_{F}^{3} + 2 {b}_{1}^{2} {μ}_{F}^{4} ) + {σ}_{E}^{4} {σ}_{F}^{2} ( 1 / {μ}_{E}^{6} ) \cdot ( 3 {b}_{3}^{2} + 4 {b}_{15} + 16 {b}_{13} {μ}_{F} + 16 {b}_{1}^{2} {μ}_{F}^{2} ) + {σ}_{E}^{4} {σ}_{F}^{4} ( 1 / {μ}_{E}^{6} ) \cdot 8 {b}_{1}^{2} . \qquad ( 7 )$$

In this equation bᵢⱼ stands for bᵢ.bⱼ

Including the said second derivatives in the calculation according to the new method allows comparing the results obtained with the results of Monte Carlo simulations. These are described, for example in the article “Characterization and optimization of CD control for 0.25 μm in CMOS applications” in SPE VOL.2726, pp 555-563 (1996.

The Monte Carlo simulation is currently used in process optimization to generate statistical CD distribution. However, the Monte Carlo approach requires substantially more calculation time and it can not be used to analyze experimental data. It has been found that the average CD value and the 3σ values obtained with the present method differs less than 0.5 nm from these values obtained with the Monte Carlo approach.

From the average value and the standard deviation as defined in equations (6) and (7), respectively the Cₚₖ parameter value for each exposure dose and focus setting can be calculated by means of equation (1). FIG. 5 shows an example of the variation of the Cₚₖ value as a function of the exposure dose (E) and focus (F). The Cₚₖ values are denoted in the vertical bar at the right side by means of a gray scale from black to white. The contour lines in FIG. 5 border areas having different gray scales corresponding to that of the bar. The Cₚₖ value increases from the left and right borders and from the lower and upper borders towards the center. The highest Cₚₖ value, in the center of the FIG. 5 is denoted by a black diamond Cₚₖ₍ₕ₎) and has a value of approximately 3 in this example. The focus setting and the exposure dose setting associated with the Cₚₖ₍ₕ₎) value are the best focus (BF) and the best exposure dose (BE) setting. The Cₚₖ value 3 is obtained for a focus value of approximately 0.25 μm and an exposure dose of approximately 23 mJI/cm².

The best focus/best exposure dose set point obtained with the new optimizing method depends on the magnitude of the focus and dose variations. As is clear from Equation 6 the average CD value differs from the CD target value for the selected set point, CD(μ_{E}μ_{F}). A good optimization process by means of the novel method BE and BF values are found for which CD(BE,BF) is not the CD design value, but, taking into account the whole distribution of exposure dose and focus, a CD distribution of which with the mean value is the CD design value. The said difference is a function of the magnitudes of the exposure dose and focus variation around their set points, μ_{E} and μ_{F}. The shift of the average CD value is caused by the non-linear variation of the CD value as a function of focus and exposure dose. The larger the variation around the set points the larger the deviation of the average CD value from the target value will be.

An example of the shift, μ_{CD-CD}_{target}, between the average CD value and the target CD value as a function of the range of focus variation FR and the range of exposure dose variation is shown in FIG. 6. FIG. 6a shows the shift for an isolated 130 nm wide feature and FIG. 6b shows the shift for such a feature from a semi-dense pattern of such features, which pattern has a pitch of 310 nm. The data plotted in these Figs. are obtained from calculations on aerial images of mask features whereby a Lumped Parameter Model is used. This model is described in the article: “Lumped Parameter Model for Optical Lithography” Chapter 2, Lithography for VLSI, VLSI Electronics-Microstructure Science, R. K. Watts and N. G. Einspruch eds., Academic Press (New York 1987) pp. 19-55. In FIG. 6 different focus ranges are plotted along the horizontal axis, whilst only two exposure dose ranges, 5% and 10%, respectively are plotted. From FIGS. 6a and 6b it is clear that the shift for the semi-dense feature is smaller than for the isolated feature. This is due to the fact that the Bossung plot, i.e. a plot as shown in FIGS. 3a and 3b, for an isolated feature has a larger curvature than the Bossung plot for a semi-dense feature. From the fact that the dots for the 5% and 10% exposure dose range coincide in both Figs. may be concluded that exposure dose variation has a negligible effect on the CD shift and that the main source for the shift is focus deviation. For a practically usable lithographic process, i.e. for a Cₚₖ>1, the focus shift is limited to approximately 3 nm. for the given examples. This value for this example does only mean that in practice the focus variation usually will not be larger than 3 nm and represents an estimation of the magnitude of the effect. It does not mean that the variation may not be larger.

The Cₚₖ optimization method allows optimizing of the focus and exposure dose targets such that the average value of the CD distribution coincides with the design CD value.

FIGS. 7a and 7b show an example of results obtained with the optimization method using the Cₚₖ parameter. These Figs. are based on simulated data of 130 nm isolated (FIG. 7a) and semi-dense structure (FIG. 7b) features In these simulations the aerial images of these features were analyzed using a Lumped Parameter Model. The simulations were performed for a projection lens having a numerical aperture (NA) of 0.63 and for a coherence factor 0.85, which means that the exposure beam fills 85% of the objective lens pupil. The dashed curve CD(des)′ corresponds to the design CD value line and the solid curves LL′ and UL′ corresponds to the design −10% and the design +10% CD value, respectively.

The small circle Cₚₖ₍ₛ₎ denotes the best focus, best exposure dose set point calculated by means of the Cₚₖ optimization method. The ellipse SA around this set point is the area of exposure dose and focus settings that is actually sampled due to the exposure dose and focus variations. The length of the main axis of this ellipse corresponds to the 6σ values of the focus distribution, which values were also used in FIGS. 6a and 6b. This ellipse does not represent the type of maximum process window that would be found with a conventional optimization method. The ellipse just represents the variation that is assumed to be present in the process under consideration. Thus, if the ellipse is within the curves LL′ and UL′, the CD values will be within the −10% and the +10% limits and this results in a Cₚₖ value larger than one. If the ellipse of actual exposure dose and focus variations exceeds the curves UL′ and LL′ part of the CD values will be larger and smaller, respectively than the +10% and −10% limits. For the situation depicted in FIGS. 7a and 7b, wherein the simulated focus and exposure dose variations are relative large and the ellipse SA for the isolated feature (FIG. 7a) exceeds the lower limit curve LL′, the optimization method predicts a Cₚₖ smaller than 1 for the lithographic process. These variations should be decreased for a reliable production process? For the semi-dense feature (FIG. 7b) the Cₚₖ is larger than 1. For the simulated process of FIGS. 7a and 7b and exposure dose latitude of 6% and a focus range of 0.35 μm were used and the standard deviation for focus and exposure dose were ⅙th (for a Gaussian distribution for which the range is approximately 6× the standard deviation) of these values, thus (σ_{E}=0.01E and σ_{F}=0.058 μm.

To demonstrate the improvement in process window optimisation of the new method with respect to the conventional method, firstly one should realize that in the conventional method one of the parameters: focus and exposure dose, is chosen and then the latitude of the other parameter is maximized. For example, if a focus range of 0.35 μm is chosen and the exposure dose latitude is maximized by means of the conventional method, a process window represented by the circle PW_{C1} in FIG. 8a and the circle PWC₂ in FIG. 8b are obtained for the isolated 130 nm feature and for this feature from a semi-dense structure, respectively. The curves LLc and Ulc in FIGS. 8a and 8b correspond to the (10%) lower and upper limits for the allowable CD values. As the image is an aerial image best focus (B3F) is per definition zero (F0.0 in the Figures. The numbers E0.97 and E1.02 means that the best exposure doses for both cases differ approximately 5%.

The best exposure dose setting obtained with the new method is different from that setting obtained with the conventional method, especially for the isolated feature. The effect decreases with decreasing pitch in the pattern.

To compare the production process quality forecasting power of the new and conventional optimization method, a Monte Carlo simulation can be used wherein the set points of FIGS. 7 and 8, a 3σ variation of 3% for the exposure dose and 3σ variation of 0.175 pun for focus are inputted. The result of such simulation is shown in FIGS. 9a and 9b. FIG. 9a relates to the isolated 130 nm feature and FIG. 9b relates to such feature from a semi-dense pattern with a pitch of 310 nm. The CD values obtained for the new (Cₚₖ) optimization method and for the conventional (classical) method are denoted by round spots and diamond spots, respectively. The lower and upper limits for the CD values are denoted by the dashed vertical lines LL and UL, respectively.

As for the semi-dense case (FIG. 9b) the Cₚₖ and classical optimization methods give the same set points for the exposure dose and focus, the simulated CD value distribution is the same for the two methods. For the isolated feature there is a significant difference in the best exposure-dose set points obtained with the Cₚₖ method and the classical method, respectively, which causes a different simulated CD value distribution for the two optimization methods. As a result, the average CD value of the distribution from the classical method differs 5.8 nm from the CD design value, whilst the average CD value of the distribution form the Cpk method is the same as the CD design value. The difference in sensitivity of the isolated feature and the semi dense feature for the type of optimization method is caused by the fact that the curvature of an iso-exposure-dose curve for the isolated feature is substantially larger than this curvature for a semi-dense feature.

The MC simulated distributions show asymmetry. To make this visible for each distribution a fitted (symmetric) Gaussian distribution: GD₁ and GD₂, respectively, having the same average value and the same standard deviation is shown in the Fig. The simulated distributions have more CD values at the left side than at the right side. For the set point obtained with the classical optimization method more CD values are within the specification than for the set point obtained with the Cₚₖ optimization method. At a first sight this may look strange, because it would mean that the percentage of CD values within specification increases as the Cₚₖ value decreases. However, it should be noted that the increase in the number of CD values within specification is obtained by the introduction of a shift of 5.8 nm between the average CD value and the CD design value. This relative large shift causes the large reduction of the value of the Cₚₖ for the classical optimization method. For many lithographic processes the uncontrolled difference between the average CD value and the design CD value, which difference is inherent to the conventional optimization method is unacceptable.

The new optimization method allows reducing this difference to zero and reducing the width of the CD value distribution. Moreover, the new method uses analytical means, the FEM model of equation (2) and, for the equation (2) embodiment, the equations (6) and (7) to calculate the Cpk from the FEM parameters so that better results are obtained than with the conventional method. The novel method uses less calculation time than the Monte Carlo method, which, moreover is rarely used for process optimization.

In the above description only two parameters, exposure dose and focus, of a lithographic process have been considered to explain the new optimization method in a simple way. However, in practice other controllable parameters of the process, like illumination setting and mask bias may, and usually have to, be included as well in an optimization process The nature of the new optimization method does allow doing so.

As an example the parameter mask bias will be considered. The meaning and the function of this parameter have been explained in the introductory part of this description. The new optimization method for a lithographic process for printing a mask pattern having sub-patterns, which comprises the same, but different pitches and different mask bias, comprises the following steps:

1) Acquire a data set, from experiments or by simulation, of a focus-exposure matrix for each of the different sub-patterns;

2) Create a model that describes the CD data as a function of focus, exposure dose and the third optimization parameter, the mask bias. This can, for example, be done in two steps. First, the six parameters of the CD(E,F) model (equation (2)) are fitted for each FEM data set. Subsequently these six parameters, bᵢ, are fitted as a function of the mask bias. (e.g. with a linear or quadratic dependence.) Alternatively, The full set of CD data as a function of energy dose, focus, and mask bias can be fitted to one model with the appropriate parameters bᵢⱼ.

3a) Determine the relationship between the average CD value and the set points and variations of the process variables (exposure dose, focus and the third variable: mask bias) by calculating:
mean CD=μ_{CD}=E_{E}[E_{F}[E_{W}[CD(E,F,W)]]]
wherein W is the mask bias and Eₓ[f(x)] is the averaging function, weighted with the probability of the distribution of the process variable x.
Eₓ[f(x)]=_{x=-∞}∫^{x=∞}p(x)f(x)dx

Herein, p(x) is the statistical distribution of the process variable, x. Examples of such distributions for the variables exposure dose and focus are given in Equations (4) and (5). Other distributions, like a uniform distribution, are possible as well.

3b) Determine the relation between the variation of the CD value (i.e. its standard deviation) and the set points and variations of the process variables (exposure dose, focus and the third parameter: mask bias), by calculating:
Standard deviation CD=σ_{CD}=√(E_{E}[E_{F}[E_{W}[(CD(E,F,W)−μ_{CD})²]]])

The results of steps 3a) and 3b) are analytic formulas, which allows quick calculation of the mean value and the standard deviation of CD.

4a) Determine for each possible E and F combination the mask bias that is needed to form a printed feature having the size of the design feature, thereby using the analytic expression for the mean value of the CD distribution of step 3a). Pre-determined values for the standard deviations of the process variables, E, F and W are used.

4b) Calculate for each possible E and F combination the variance of the CD distribution using the analytic expression for the standard deviation of the CD distribution of step 3b). Again, predetermined values for the standard deviations of the process variables, E, F, W are used.

5) Determine for each possible E and F combination the process latitudes in the form of the Cₚₖ values of the CD distributions using the mean value and the standard deviation from steps 4a) and 4b.

In this way the Cₚₖ as a function of exposure dose and focus: Cₚₖ (EF) is obtained (in step 5)) and the corresponding mask bias W(E,F) in step 4a).

Now some examples of use of this calculation process will be described.

To determine the best focus (BF) best exposure dose (BE) combinations for a given mask bias for a single pattern structure: first the set of all (E,F) combinations is determined for which the mask bias W(E,F) equals the required mask bias. Subsequently from this set of (E,F) combinations the BE value and BF values providing the highest Cₚₖ(E,F) value is derived. Then the BE value and the BF value and the corresponding process latitude Cₚₖ(BE,BF) are known.

To determine the optimum mask bias for a single pattern structure, the maximum Cₚₖ(E,F) as a function of E and F is determined, which results in: best exposure dose (BE) and best focus (BF). From BE, and BF the corresponding optimum mask bias: W(BE,BF) is calculated. The best exposure dose for printing this pattern structure is then also known.

To determine the best exposure dose and the best focus and the appropriate mask biases for a mask pattern having different structures, for each of these structures the Cₚₖ(E,F) and the corresponding mask bias W(E,F) should be calculated. Subsequently, for each possible E, F combination, the pattern structure that gives the lowest Cₚₖ(E,F) value is determined. This yields a data set of lowest Cₚₖ values as a function of Energy and focus, which can be called critical Cₚₖ(E,F); CrCₚₖ(E,F) and a data set of corresponding mask bias values per structure, which may called structure mask; StrCₚₖ(E,F). The maximum value of CRCₚₖ(E,F) now gives the exposure dose and focus setting, which give the best performance for the most critical one of the different structures. This setting is the overall BE,BF set point that provides overall process performance CrCₚₖ(BE,BF)). The corresponding optimum mask bias for the different pattern structures follows from an evaluation of StrCp(BE,BF) for each pattern structure individually.

If appropriate also a limited optimization can be carried out, whereby one of the process variables, for example the mask bias, of a structure is fixed to 0.

The use of an analytical model in step 2) allows calculating the Cₚₖ parameter analytically as a function of the coefficients of the model equation. Thereby equations (4) and (5) for the exposure-dose and focus values and equations (6) and (7) for the average CD value and the CD distribution should be extended with terms comprising values for the mask bias.

The data of step 1) can be obtained by a simulation program or by printing the feature a number of times, each time with a different exposure dose and/or focus setting, in a resist layer on top of the substrate, developing the resist and measuring the dimension of the printed features.

The method can also be used to optimize the process window for a process for simultaneously printing features having different dimensions. Then a mask pattern having different structures i.e. pattern areas having different feature sizes and/or pitches is used. The Cₚₖ of the critical structure, i.e. the structure with the smallest Cₚₖ at the predetermined focus and exposure dose, is used then to determine the overall process latitude for all structures in the mask pattern.

The method of the invention provides freedom to chose the number of process parameters and their type to be included in the optimization process. Under circumstances it suffices to optimize the process by using only focus and exposure dose. However, it is also possible to include instead of or in addition to, the mask bias one or more another process parameter(s), like illumination and scattering bars in the mask pattern, in the optimization process. The higher the number of process parameters included in the optimization method, the more accurate and sophisticated the optimization method will be. Whereas the mask bias is linearly related tot the exposure dose and can be optimized together with optimization of the exposure dose and focus, optimization of other process variables, for example illumination setting (NA setting, a setting), which are not linearly related to exposure dose and focus, requires more calculations of the type described above to find the value of the relevant variable for the highest Cₚₖ.

All process parameters are processed to obtain an optimum (maximum) value of one overall process parameter, Cₚₖ. Once this value has been established, the values of the considered process parameters are known so that a lithographic design engineer can provide an optimum process window, i.e. can prescribe the settings in a lithographic projection apparatus, such as focus, exposure dose and illumination setting. Moreover, the optimization method of the invention allows designing a mask of the optimum type and having optimum mask features, like mask bias and scattering bars. Mask types from which can be chosen are: amplitude (binary) mask, phase mask, transmission mask, attenuated phase shift mask and alternating phase shift mask. Illumination setting may include setting of the coherence factor, the type of illumination (circular, ring-shaped, dipole or quadrupole) and the size of the illuminating beam portions. Also other variables of the lithographic process, like bake and etch conditions for the resist after this has been exposed may be taken in consideration.

By using the new optimization method the quality of a lithographic process and the yield of such a process as well as the quality of the device manufactured by means of the process are improved. Thus the invention is embodied in the manufacturing process and in the device.

For carrying out the method a dedicated computer program product is used for programming a programmable

The invention is not limited to a specific lithographic projection apparatus or to a specific device, like an integrated circuit (IC). The invention can be use in several types of lithographic projection apparatus known as stepper and step-and-scanner utilizing exposure radiation of different wavelength from ultra violet UV to deep UV ([)UV) and even extreme UV (EUV, having a wavelength in the order of 13 nm). The device may be an IC or another device having small feature sizes, like a liquid crystal panel, a thin film magnetic head, an integrated or planar optical system etc.

1. A method of determining best process variables setting that provides optimum process window for a lithographic production process comprising transferring a mask pattern into a substrate layer, which process window is constituted by latitudes of controllable process parameters and which method comprises the steps of:
acquiring a data set of a focus-exposure matrix for a feature of the mask pattern having critical dimension (CD), which feature has a predetermined design CD value being the CD value that should be approximated as close as possible when transferring the feature to the substrate layer, and
checking whether transferred images of the feature meet design tolerance condition, and determining which combination of values of controllable process variables provides the CD value closest to the design value and the best process latitude, characterized in that the process of checking and determining the best combination comprises the steps of:
1) defining a statistical distribution of relevant process variables, the parameters of the distribution being determined by estimated or measured variations of the process variables;
2) fitting the coefficients (b₁-bₙ) of an analytical model (CD(E, F)) that describes the CD value as a function of the process variables focus (F) and exposure dose (E);
3) calculating the average CD value and the variance of the CD distribution using the analytical model CD(E, F) of step 1);
4) determining quantitatively how the CD distribution fits to a desired process control parameter Cₚₖ; and
5) determining the best process setting for the design feature by determining the exposure-dose value and the focus value which provide a maximum Cₚₖ value.

2. A method as claimed in claim 1, wherein at least one other process variable is included, characterized in that a number of values for the another parameter are introduced, in that in step 1) the coefficients of the model are interpolated as a function of the other parameter, in that between step 2) and step 3) an additional step is carried out comprising:
2a) determining for each possible E and F combination the value of the other variable that is needed to form a printed feature having the size of the design feature, thereby using the interpolated E and F values of step 2);
in that steps 3) and 4) are carried out for each value of the other process parameter, and in that in step 5) the exposure dose value, the focus value and the value of the other parameter which provide the maximum Cₚₖ value are determined.

3. A method as claimed in claim 1 for optimizing focus and exposure-dose settings, characterized in that the analytical model used in step 1) uses the following relationship between the CD value and the focus and exposure-dose values (E; F):
CD(E,F)=b₁.(F²/E)₋+b₂.F²+b₃.(F/E)+b₄.F+b₅.(1/E)+b₆
wherein b₁-b₆ are the coefficients of the model.

4. A method as claimed in claim 3, for Gaussian focus and exposure dose distributions, characterized in that for the calculation in step 3) of the average CD value (μ_{CD}) and the variance of the CD distribution (σ_{CD}) the following equations are used:
$${σ}_{CD}^{2} = {σ}_{F}^{2} ( 1 / {μ}_{E}^{2} ) \cdot ( B 32 + 4 {b}_{13} {μ}_{F} + 4 {b}_{1}^{2} {μ}_{F}^{2} ) + {σ}_{F}^{2} ( 1 / {μ}_{E} ) \cdot ( 2 {b}_{34} + 4 ( {b}_{23} + {b}_{14} ) {μ}_{F} + 8 {b}_{12} {μ}_{F}^{2} ) + {σ}_{F}^{2} \cdot ( {b}_{4}^{2} + 4 {b}_{24} {μ}_{F} + 4 {b}_{2}^{2} {μ}_{F}^{2} ) + {σ}_{F}^{4} ( 1 / {μ}_{E}^{2} ) \cdot 2 {b}_{1}^{2} + {σ}_{F}^{4} ( 1 / {μ}_{E} ) \cdot 4 {b}_{12} + {σ}_{F}^{4} \cdot 2 {b}_{2}^{2} + {σ}_{E}^{2} ( 1 / {μ}_{E}^{4} ) \cdot ( {b}_{5}^{2} + 2 {b}_{35} {μ}_{F} + ( {b}_{3}^{2} + 2 {b}_{15} ) {μ}_{F}^{2} + 2 {b}_{13} {μ}_{F}^{3} + {b}_{1}^{2} {μ}_{F}^{4} ) + {σ}_{E}^{2} {σ}_{F}^{2} ( 1 / {μ}_{E}^{4} ) \cdot ( 3 {b}_{3}^{2} + 2 {b}_{15} + 14 {b}_{13} {μ}_{F} + 14 {b}_{1}^{2} {μ}_{F}^{2} ) + {σ}_{E}^{2} {σ}_{F}^{2} ( 1 / {μ}_{E}^{3} ) \cdot ( 2 {b}_{34} + 4 ( {b}_{23} + {b}_{14} ) {μ}_{F} + 8 {b}_{12} {μ}_{F}^{2} ) + {σ}_{E}^{2} {σ}_{F}^{4} ( 1 / {μ}_{E}^{4} ) \cdot 7 {b}_{1}^{2} + {σ}_{E}^{2} {σ}_{F}^{4} ( 1 / {μ}_{E}^{3} ) \cdot 4 {b}_{12} + {σ}_{E}^{4} ( 1 / {μ}_{E}^{6} ) \cdot ( 2 {b}_{5}^{2} + 4 {b}_{35} {μ}_{F} + ( 2 {b}_{3}^{2} + 4 {b}_{15} ) {μ}_{F}^{2} + 4 {b}_{13} {μ}_{F}^{3} + 2 {b}_{1}^{2} {μ}_{F}^{4} ) + {σ}_{E}^{4} {σ}_{F}^{2} ( 1 / {μ}_{E}^{6} ) \cdot ( 3 {b}_{3}^{2} + 4 {b}_{15} + 16 {b}_{13} {μ}_{F} + 16 {b}_{1}^{2} {μ}_{F}^{2} ) + {σ}_{E}^{4} {σ}_{F}^{4} ( 1 / {μ}_{E}^{6} ) \cdot 8 {b}_{1}^{2} .$$
wherein b₁-b₆ are the coefficients of the analytical model, μ_{E} and μ_{F} are the average values of the exposure dose and focus distributions, respectively, σ_{E} and σ_{F} are the standard deviations of these distributions, and bᵢⱼ stands for bᵢ×bⱼ.

5. A method as claimed in claim 2, characterized in that the another process variable is a mask bias.

6. A method as claimed in claim 1 for a process for printing a mask pattern having different structures, characterized in that the Cₚₖ of the structure having the smallest Cₚₖ value at the predetermined focus and exposure dose is used to determine the overall process window for all structures in the mask pattern at that focus and exposure dose.

7. A method for setting optimum process window for use in a lithographic production process, which process comprises transferring a mask pattern in a substrate layer and which method comprises determining optimum process window and setting controllable process variables according to this window, characterized in that the optimum process window is determined by the method as claimed in claim 1.

8. A lithographic process for manufacturing device features in at least one layer of a substrate, which process comprises transferring a mask pattern into the substrate layer by means of a projection apparatus thereby using an optimized process window defined by latitudes of controllable process parameters, characterized in that the process window is optimized by of the method of claim 7.

9. A device manufactured by the lithographic process as claimed in claim 8.

10. A computer program product for use with the method of claim 1 and comprising programmable blocks for programming a programmable computer according to the processing steps of the method.

11. A lithographic mask having a mask pattern, which comprises pattern features having been optimized by the method of claim 1.
